(19) United States
(12) Patent Application Publication
(10) Pub. No.: US 2015/0093221 A1
(43) Pub. Date: Apr. 2, 2015

(54) Intermediate Container For A Front Loading Refuse Container

(71) Applicant: The Curotto-Can, LLC, Chattanooga, TN (US)

(72) Inventor: Brian T. PARKER, Signal Mountain, TN (US)

(21) Appl. No.: 14/043,406

(22) Filed: Oct. 1, 2013

(51) Int. Cl. B65F 1/14; B65F 3/04

(52) U.S. Cl. CPC B65F 1/1452; B65F 3/041; B65F 2003/023
USPC 414/303; 414/408

(57) ABSTRACT

A collection arm for a refuse vehicle or intermediate container has a collection arm adapted to be coupled with the refuse vehicle or the intermediate container. The refuse arm includes a pivot mechanism to secure it with a bumper of the vehicle or with the container. A telescopic boom is adapted to couple with the pivot mechanism. The boom has a grasping mechanism coupled with an end of the telescopic boom. The grasping mechanism moves garbage cans from a pick up position to an empty position.

### FIELD

The present disclosure relates to intermediate containers for front loading refuse vehicles and, more particularly, to an intermediate can that includes a pivotal arm on the container or the front bumper of the vehicle.

### BACKGROUND

Various types of containers have been disclosed. U.S. Pat. Nos. 8,496,427; 8,092,141; 7,553,121, and 7,210,890 exist in the art. These intermediate containers are known in the art as Curotto cans. The Curotto cans usually include a side loading robotic arm at the rear of the container. Also, prior Curotto can patents illustrated the side loading robotic arm at the front of the container. The arm is movable in a slide that is secured on the outer wall of the container. While these types of side loading arms on intermediate containers work satisfactorily for their intended purposes, designers strive to improve the art.

Accordingly, the present disclosure provides an intermediate container with a telescoping side loading arm. The side loading arm may be pivotally connected to the front bumper of the refuse vehicle. Alternatively, the side loading robotic arm may be pivotally attached to the front or rearmost wall of the intermediate container, when the intermediate container is positioned on the front loading forks of a refuse collection vehicle. Alternatively, the side loading arm may be pivotally connected with the sidewalls of the intermediate container. Additionally, the arm may pivotally connected within the intermediate container.

### SUMMARY

Accordingly to a first aspect of the disclosure, a refuse vehicle with a front loading mechanism has an intermediate collection container coupled with the forks of the front loading mechanism. A collection arm, for picking up refuse cans, is mounted on a front bumper of the refuse vehicle. The collection arm includes a pivot mechanism to enable vertical adjustment of the collection arm. A pivot is positioned on the bumper and is coupled with the collection arm pivoting mechanism. A pivot bearing assembly removably couples the telescoping boom and is adapted to couple with the bumper. The collection arm provides telescoping movement of the grabber to move the grabber toward and away from the refuse vehicle.

According to a second aspect of the disclosure, an intermediate can, to couple with the fork of a front loaded refuse vehicle, comprises a bottom wall, a front wall, a rear wall and a pair of side walls between the front and rear walls forming the intermediate can. A telescoping boom is adapted to be coupled with a wall of the intermediate can. A grasping mechanism is coupled with an end of the telescoping boom. The grasping mechanism is adapted to grasp refuse cans. The telescoping boom is pivotally secured to a wall of the intermediate container. A pivot bearing assembly removably couples the telescoping boom and is adapted to couple with the intermediate container wall. The arm enables pick up of refuse cans above and below grade of a surface on which the vehicle is traveling.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an intermediate can and a collection arm positioned on a refuse vehicle.

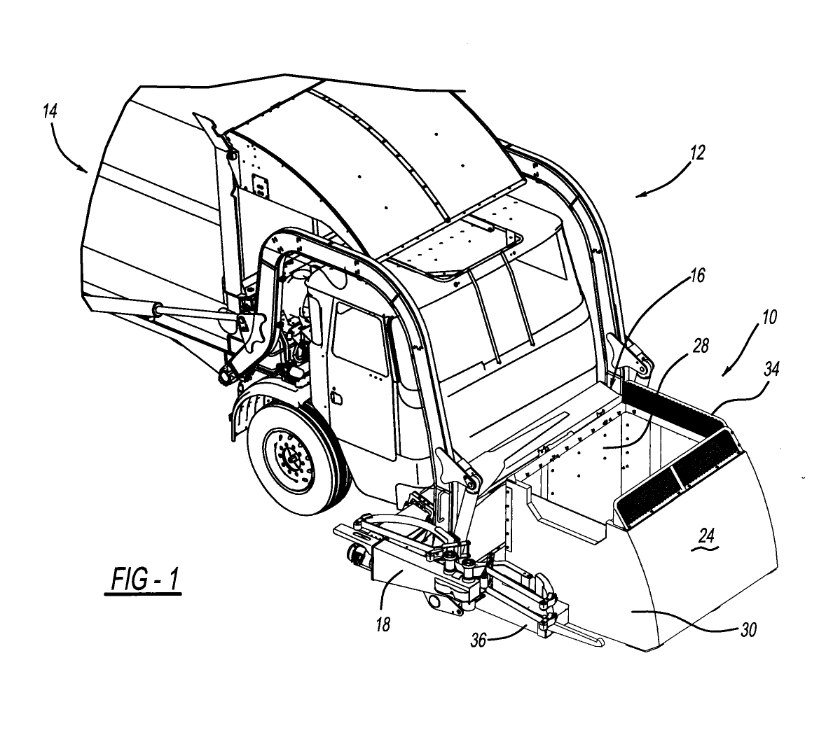

FIG. 2 is a top plan view of FIG. 1.

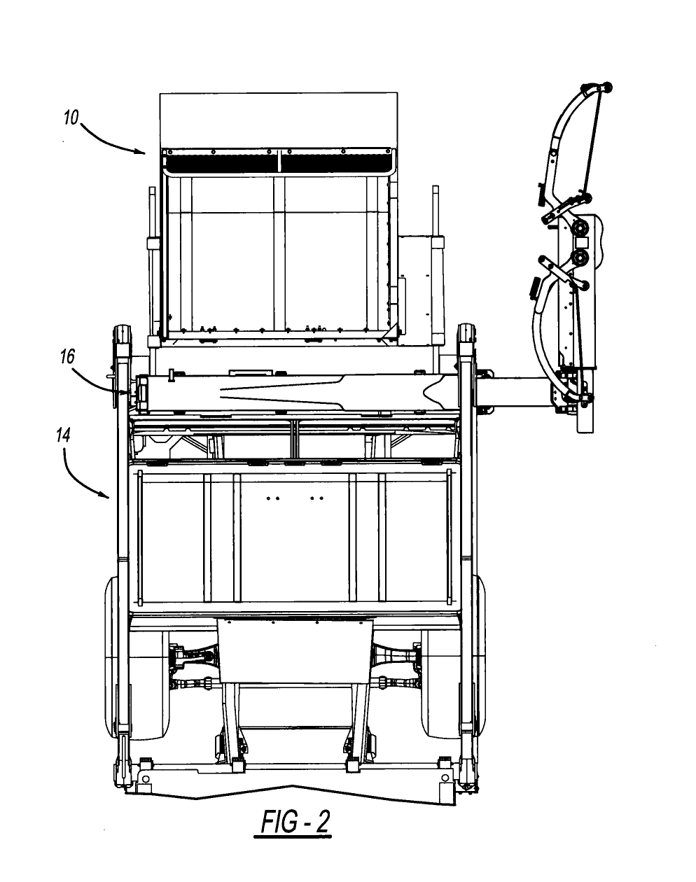

FIG. 3 is an exploded view of FIG. 1.

FIG. 4 is a perspective view of an intermediate can with a mounted collection arm.

FIG. 5 is a top plan view of FIG. 1.

FIG. 6 is an exploded view of FIG. 4.

FIG. 7 is a perspective view of another embodiment of the intermediate can and collection arm.

FIG. 8 is a perspective view of an alternate embodiment of the intermediate can and collection arm.

### DETAILED DESCRIPTION

Example embodiments will now be described more fully with reference to the accompanying drawings.

Turning to the figures, an intermediate can 10 is loaded on the front loading forks 12 of a refuse collection vehicle 14. A collection arm 16 is mounted on the bumper 18 of the refuse collection vehicle 14. The refuse collection vehicle 14 includes a mounted container 20 that includes an open hopper 22 that receives refuse from the intermediate can 10.

The intermediate can 10 has an overall box shape with a front wall 24, a rear wall 26, sidewalls 28, 30, a bottom 32 and an open top 34. Thus, refuse can be positioned into the intermediate container 10 through the open top 34 and retained in the intermediate container 10 until it is dumped into the hopper 22. Also, the intermediate container 10 includes a pair of channels 36 that enable the forks 12 to pass therethrough to enable lifting and transporting of the intermediate container 10.

The container collection arm 16 includes a telescoping boom 42 and a grasping assembly 44. The grasping assembly 44 is secured to the boom 42 via a rotary actuator 46. The rotary actuator 46 manipulates the grasping assembly 44 to level the refuse can during lifting. Additionally, the rotary actuator 46 initiates dumping of the container into the intermediate container 10. A hose track 48, housing the hydraulic hoses, is positioned on the boom 42. The hydraulic hoses are carried by the hose track 48 to the rotary actuator 46 and grasping assembly. The hose track 48 moves along the boom 42.

The grasping assembly 44 includes a link arm 45 coupled with the rotary actuator 46. Additionally, a pair of fingers 41, 43 is actuated from the link arm 45 to capture the refuse can. The link arm 45 is illustrated in a non-offset position for close gripping of the refuse can or for a storage position. The fingers 41, 43 include a sensor 49. The sensor 49 may be of the pressure or positioning type to enable proper positioning of the gripping mechanism fingers 41, 43 on the refuse can prior to the dump sequence. Additionally, the fingers 41, 43 may include a sensor such as a load cell 51 or the like that enables a determination of the weight of the refuse can prior to the dumping sequence. By determining the weight of the refuse can, dynamically, this enables the speed of the arm 16, during the dump sequence, to be adjusted based upon the weight of the refuse can. Thus, with a lightweight refuse can, the boom 42 may operate rapidly through the dump sequence to dump the refuse can. In the event the refuse can is heavy (e.g., 100 to 300 lbs.), the boom 42 can lift the refuse can slowly and proceed through the dump sequence to dump the refuse can at a slower speed. Alternatively, the hydraulic system could be utilized, via an algorithm relating weight to the pressure/flow characteristics, to determine the weight of the refuse can. Thus, the hydraulic pressure could be monitored to determine the weight and thus the sequence of dumping the refuse can.

The boom 42 generally includes a plurality of stages that enable the boom 42 to telescope outward and inward to pick up and dump a refuse can. The boom 42, with stages, can have a desired length and is preferably between 8 to 16 feet.

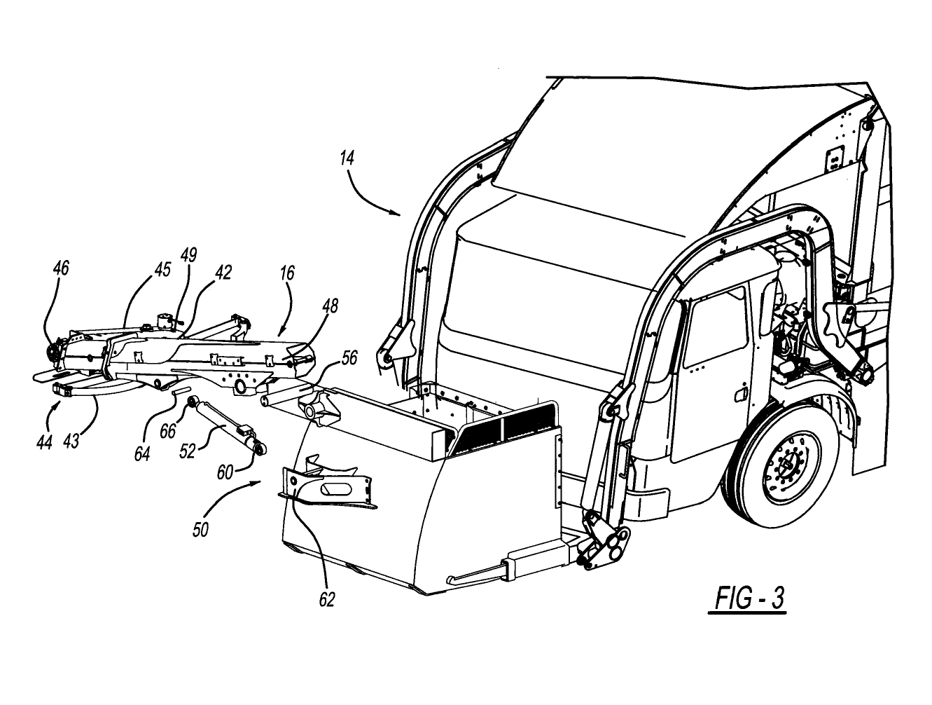

The boom 42 is secured onto the bumper 18 by a mounting assembly 50 and a movable cylinder 52. The mounting assembly 50 is secured to the bumper 18. A bearing journal 56 enables the boom 42 to rotate about the bearing journal axis. The mounting assembly 50 includes a base 54. The base 54 includes the bearing journal 56 that receives the boom 42. The bearing journal 56 is positioned inside of a base 54 that is secured to the bumper, as illustrated in FIG. 3.

The pivot cylinder 52 includes a trunnion 62 mounted in a trunnion mount 60. The trunnion mount 60 enables the cylinder 52 to pivot along the axis of the trunnion pin 62. Thus, as the cylinder 52 is extended and retracted, the trunnion mount 60 enables the piston to rotate about the trunnion pin axis. As this occurs, the boom 42 is rotated about the bearing journal 56 which provides vertical movement at the end of the boom 42 that includes the rotary actuator 46. The cylinder 52 includes a mounting pin 64 that passes through a clevis 66 on the boom 42 so that the cylinder 52 is rotatably secured with the boom 42.

As can be seen in FIG. 3, due to the nature of the mounting assembly 50, the container collection arm 16 can be easily removed from the mounting assembly 50. The container collection arm 16 can easily be repaired or replaced.

Thus, by actuating the cylinder 52, the boom 42 may be moved in a first degree of movement to provide vertical movement of the grasping assembly 44. Additionally, the boom 42 can be extended to provide a second degree of freedom of movement to move the grasping assembly horizontally. Further, the rotary actuator 46 can be rotated up and/or down to compensate for grasping the refuse can. Thus, the container collection arm 16 is capable of picking up containers above and below the street grade the vehicle is traveling on. Additionally, the movement enables the opening of the refuse can to remain parallel to the ground regardless of the grade. Thus, this prevents tipping and loss of refuse in the refuse can.

Additionally, an operator override may be present to enable the grasping of refuse cans that are above and below the street grade of the vehicle. This requires the arm to be taken out of a normal range of operation for grasping the refuse can. The grasping sequence can be overridden by the operator so that the refuse can may be picked up above and below street grade of the vehicle.

The container collection arm 16 moves between a pickup and a dump position. In the pickup position, the boom 42 is extended slightly when the refuse can is on the ground and grasped by the grasping mechanism 44. The boom 42 is rotated upwardly as the piston cylinder 52 is extended. Additionally, the rotary actuator 46 compensates to maintain the refuse can in an upright position. The piston cylinder 52 continues to extend as the boom continues to retract. Also, the rotary actuator 46 continues to rotate until the container reaches a dump position. The rotary actuator 46 is rotated so that the container dumps into the intermediate container 10. At this position, the rotary actuator 46 can be moved in a forward and reverse direction to “shake” the refuse can to provide an extra refuse evacuation sequence during dumping. Alternatively, a vibration mechanism may be secured with the grasping mechanism 44 to “shake” the refuse can to provide an extra refuse evacuation sequence during dumping. The cylinder 52, boom 42 and rotary actuator 46 are activated to reposition the refuse can back onto the ground surface. Thus, the container collection arm 16 enables the container to be brought to a dumping location in a direct path from any reached distance while maintaining the refuse can in an upright condition. This reduces the possibility of spillage of the refuse can contents.

The rotary actuator 46 ensures that the refuse can is emptied. The rotary actuator, vibration mechanism, or other shaking devices, not directly related to the lifting motion, will enable the refuse can to be emptied without adding loads and stresses to the main lifting stages of the boom 42. Additionally, a system to determine whether the container is empty may be added to the container collection arm 16. It will automatically modify the container collection arm 16 motion to empty the refuse can. Refuse can status can be derived from a number of methods such as weight, visual sensing, ultrasonic radar or the like which will transmit a signal back to the main lift controller. The information will be used to either initiate shaking of the refuse can to empty its contents or prevent the operator from extraneous shaking movement of the refuse can. This reduces wear on the lifting arm and increases operator productivity by eliminating unneeded actions at each collection point.

Additionally, a sensor 75 may be positioned on the rotary actuator link arm 45. The sensor 75 ensures that the link arm 45 is level with the grade of the ground. This enables the refuse can opening to always remain parallel with the ground prior to the dump sequence. This auto leveling feature enhances the ability to enable the refuse can to be maintained upright as well as to be in a proper position for dumping. Also, sensor 75 will allow for the link arm 45 and grasping mechanism 44 to be rotated to a perpendicular position in reference to the ground so that containers that are not in an upright position can be collected.

A hydraulic system (not shown) is used to operate the grasping assembly 44 and the piston cylinder 52. The hydraulic system is coupled with the vehicle hydraulic system.

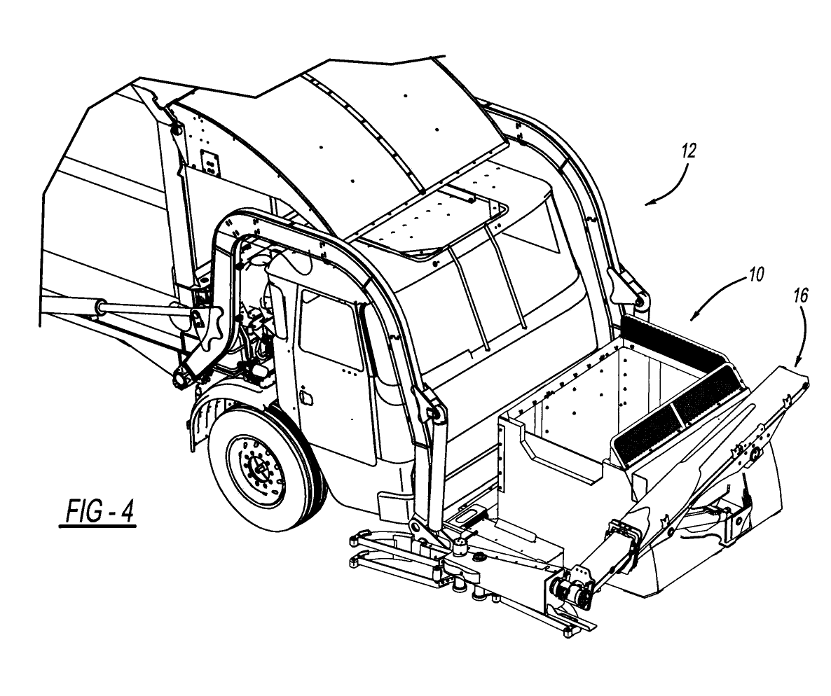

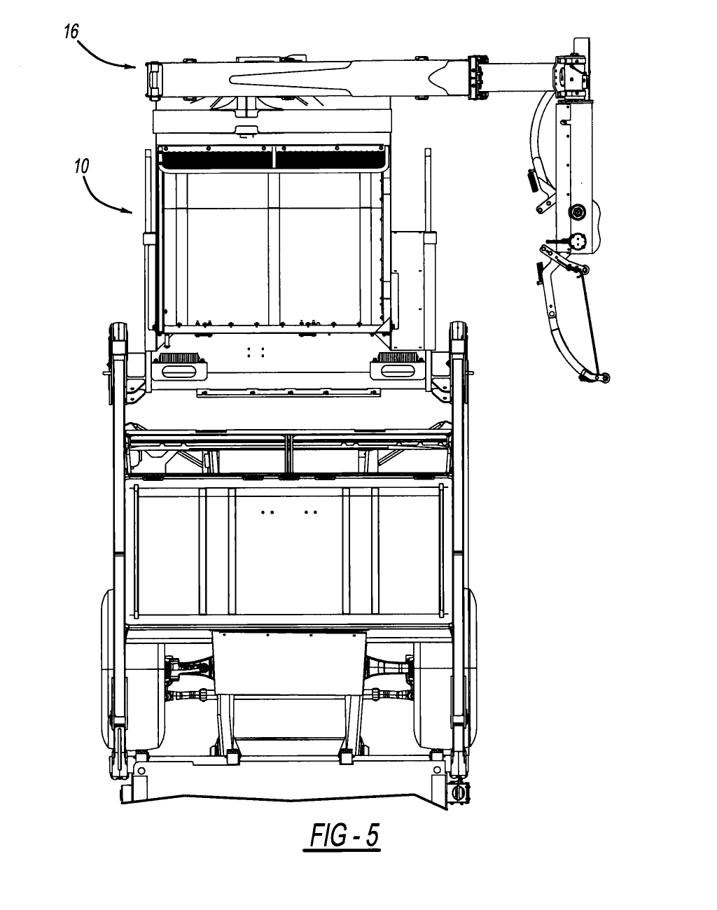

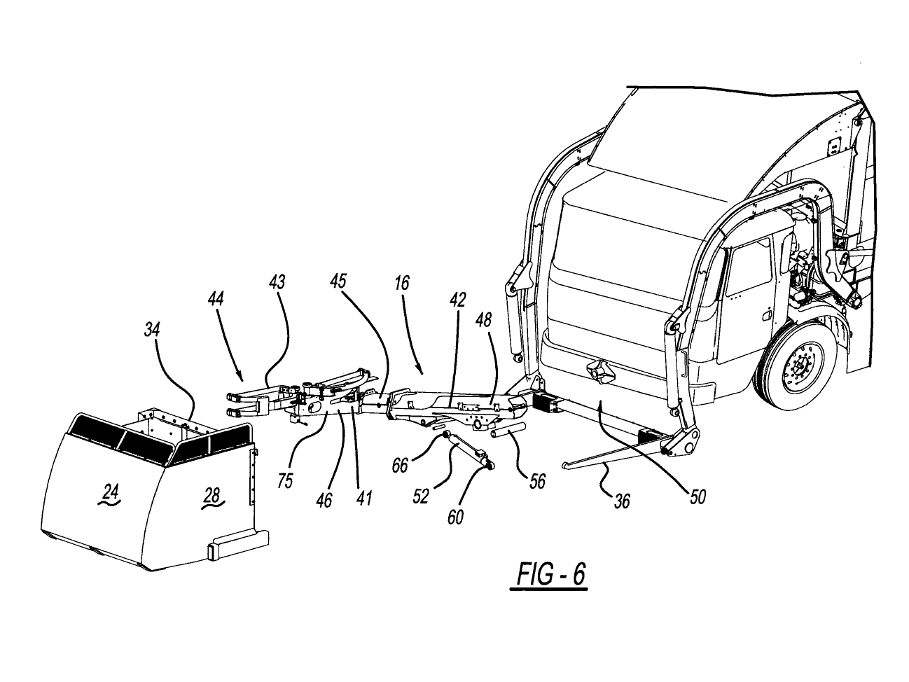

Turning to FIGS. 4-6, an alternative embodiment is illustrated. Here, the collection arm is like that previously discussed. The collection arm 16 is positioned on the front wall 24 of the container. The collection arm 16 and mounting assembly 50 and movable cylinder 52 are the same as those previously described. Thus, the same reference numerals are utilized to identify the features of the collection arm. The collection arm 16 operates as previously described.

Additionally, the collection arm 16 may be positioned onto the rear wall 26 or either side wall 28, 30 of the intermediate container 10.

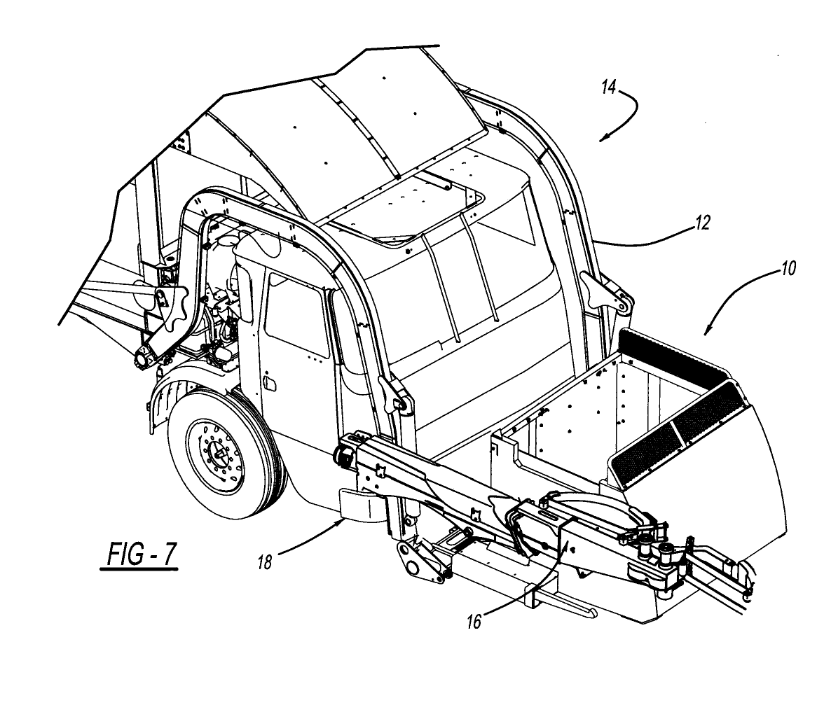

Turning to FIG. 7, the collection arm 16 is illustrated mounted on top of the bumper 18. Here, the mounting assembly 50 is mounted to the top of the bumper. The collection arm 16 operates as disclosed above.

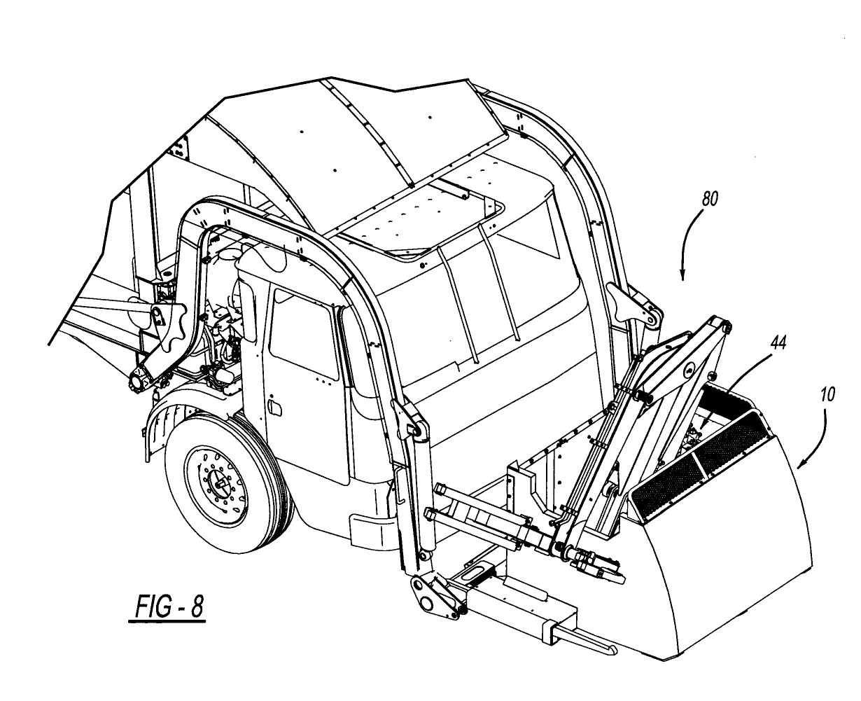

FIG. 8 illustrates an additional embodiment of the apparatus. Here, a knuckle boom lift 80 is positioned inside of the intermediate container 10. The knuckle boom 80 lift is capable of moving outside of the intermediate can 10 to pick up a refuse can to dump it inside the intermediate container 10. The grasping assembly 44 is connected to the knuckle boom lift 80 by a rotary motor 46 so that upon picking up the refuse can and returning it to the intermediate container 10. The refuse can be dumped into the intermediate container 10.

The description of the disclosure is merely exemplary in nature and thus, variations that do not depart from the gist of the disclosure are intended to be within the scope of the disclosure. Such variations are not to be regarded as a departure from the spirit and scope of the disclosure.

What is claimed is:

1. A refuse vehicle having a front loading fork mechanism comprising:
an intermediate collection container coupled with the fork mechanism;
a collection arm for picking up refuse cans, the collection arm mounted on a front bumper of the refuse vehicle;
the collection arm including a pivot mechanism for enabling vertical adjustment of the collection arm; and
a pivot on the bumper coupled with the collection arm pivot mechanism.

2. The refuse vehicle of claim 1, wherein the arm is telescoping providing movement of the collection arm toward and away from the vehicle.

3. The refuse vehicle of claim 1, wherein the pivot is mounted on the front of the bumper.

4. The refuse vehicle of claim 1, wherein the pivot is mounted on top of the bumper.

5. An intermediate container for coupling with a fork of a front loading refuse vehicle comprising:
a bottom, a front wall, a rear wall and a pair of sidewalls between the front and rear walls forming the intermediate container;
a telescoping boom adapted for coupling with the intermediate container, a grasping mechanism coupled with an end of the telescoping boom, the grasping mechanism adapted for grasping containers, the grasping mechanism moving the container between a pick up position and an empty position; and
the telescoping boom adapted to be pivotally secured to the wall of the intermediate container.

6. The intermediate can of claim 4, further comprising a pivot bearing assembly removably coupling the telescoping boom and adapted for coupling with the wall of the intermediate container.

7. The intermediate container of claim 4, further comprising a cylinder coupled with the telescoping boom for moving the boom.

8. The intermediate container of claim 6, wherein the pivot bearing assembly is on the front wall.

9. The intermediate container of claim 6, wherein the pivot bearing assembly is on the rear wall.

10. The intermediate container of claim 6, wherein the pivot bearing assembly is on one of the side walls.

11. The refuse vehicle according to claim 1, wherein the pivot mechanism enables lateral adjustment of the collection arm.
